(19) United States
(12) Patent Application Publication
(10) Pub. No.: US 2010/0252683 A1
(43) Pub. Date: Oct. 7, 2010

(54) Conjoining of a cross beam to a structure part

(75) Inventor: Carsten Paul, Garstedt (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: Airbus Operations GmbH, Hamburg (DE)

(21) Appl. No.: 12/750,904

(22) Filed: Mar. 31, 2010

Related U.S. Application Data
(60) Provisional application No. 61/165,526, filed on Apr. 1, 2009.

(30) Foreign Application Priority Data
Apr. 1, 2009 (DE) 102009009015858.8

(51) Int. Cl. B64C 1/06

(52) U.S. Cl. 244/131

(57) ABSTRACT

A conjunction for mounting a cross beam to a structure part of an aircraft fuselage by means of at least one conjunction device wherein the conjunction device defines a circular path on which loads acting on the cross beam are applied in the structure element.

Priority is claimed to U.S. Provisional Application No. 61/165,526, filed on Apr. 1, 2009 and to German Patent Application No. 10 2009 015 858.8, filed on Apr. 1, 2009. The entire disclosure of both applications is incorporated by reference herein.

The present invention concerns the conjoining of a cross beam to a structure part of an aircraft fuselage wherein at least one conjunction device attaches the cross beam to the structure part.

### BACKGROUND

Cross beams in aircraft fuselages often form the supporting structure for a floor. The cross beams are usually attached at their ends to ribs and are supported via struts. Mounting the cross beams to the ribs takes place via a multiplicity of rivets, which are arranged in parallel rows and form a rectangular pattern. Here the rivets that are located furthest from a virtual centre point of the rivet pattern accommodate the largest forces.

What is disadvantageous in this type of mounting is that the loads that act on the cross beam are in principle distributed onto the corner rivets of the rectangular rivet pattern. The other rivets of the rivet pattern are subjected to lower loads, but are nevertheless dimensioned in a similar manner to these corner rivets. This type of dimensioning has a disadvantageous effect on the aircraft weight. It is therefore often usual to dimension only the two outer rows of rivets running in the transverse direction of the aircraft in the same manner as the corner rivets and to dimension the inner rows of rivets such that they are weaker. However, this has the disadvantage that the outer and inner rows of rivets have different sizes of rivet hole, which both renders the drilling of the rivet holes more resource intensive, and also renders the setting of the rivets prone to defects.

### SUMMARY OF THE INVENTION

An object of the present invention is to provide a conjunction between a cross beam and a structure part of an aircraft fuselage that avoids the disadvantages cited above.

A conjunction according to the invention has at least one conjunction device to attach a cross beam to a structure part of an aircraft fuselage, which defines a circular path for the introduction of cross beam loads into the structure part.

One advantage of the solution according to the invention consists in the fact that in comparison to the cross beam conjunction of known art described above an optimised introduction of force from the cross beam into the least one conjunction device, and from the conjunction device into the structure part, takes place via the circular path.

In one example of embodiment a multiplicity of conjunction devices forms the circular path. In this manner all conjunction devices have the same separation distance from the centre point of the circle, and the load acting on the cross beam is distributed onto all the conjunction devices evenly, and not just onto some of them. Accordingly the conjunction devices can be dimensioned to be of weaker design compared with the prior art. Furthermore all the conjunction devices can have the same dimensions, so that the holes in the cross beam and in the structure part for the accommodation of the conjunction devices have the same internal diameter and a single drilling template can be used accordingly. The risk of defective drilling or defective setting of the conjunction devices is significantly reduced. Likewise the number of conjunction devices can be reduced.

A second circular path can be provided, which is likewise formed from a multiplicity of conjunction devices, and runs concentrically with the first circular path. Likewise at least one further concentric row of rivets can be conceived.

In particular it is advantageous if the circular paths are arranged concentrically with a locating bore introduced in the cross beam and into the structure part. In this manner any material weakening of the cross beam in the conjoining region caused by the locating bore does not have a negative effect on any individual conjunction device.

The conjunction devices are preferably rivets. It should be noted that the rivets are to be understood as an example of a conjunction device. Thus screws or pins are also conceivable.

Another example of embodiment envisages designing the conjunction device in the form of a bolt. This solution has the advantage that the cross beam can be quickly replaced. In particular in the case of freighter aircraft, in which damage to cross beams often occurs, it must be possible to carry out a cross beam replacement quickly.

In one example of embodiment the bolt has a cross-sectional area that corresponds to the sum of the individual cross-sectional areas of the rivets required for the conjunction.

The bolt can be guided in bushes, whereby the bush inserted into the structure part preferably has a cylindrical inner wall, and the bush in the cross beam has a conical inner wall. The conical inner wall effects a self-centering of the cross beam relative to the structure part, so that even in the event of distortion of the structure part a replacement of the cross beam can be carried out.

Other advantageous examples of embodiments are the subject of further dependent claims.

### BRIEF DESCRIPTION OF THE DRAWINGS

In what follows preferred examples of embodiment of the invention are elucidated in more detail with the aid of schematic representations. In the figures:

FIG. 1 shows a plan view onto a first example of embodiment in accordance with the invention, and

FIG. 2 shows a plan view onto a second example of embodiment in accordance with the invention.

### DETAILED DESCRIPTION

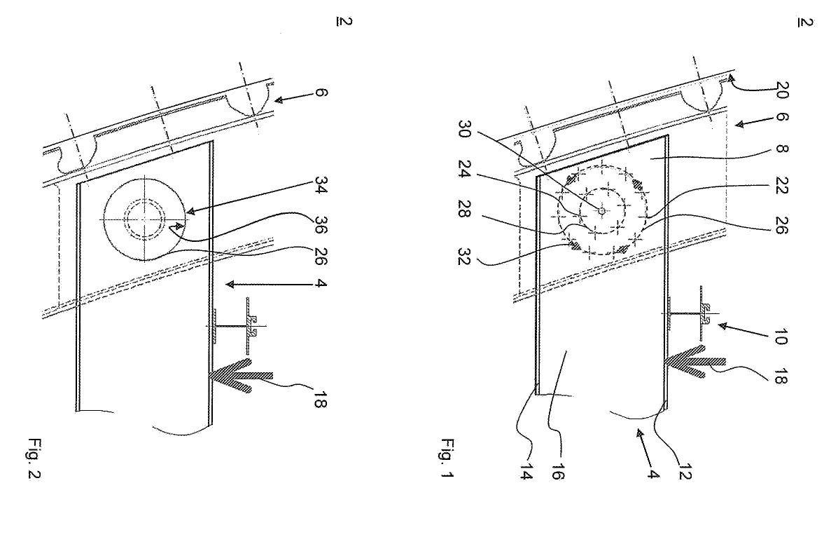

FIG. 1 shows a first example of embodiment of a conjunction 2 according to the invention between a cross beam 4 and a structure part 6 of an aircraft fuselage. The cross beam 4 extends in the direction across the aircraft fuselage and at each end is attached with an end section 8 to the structure part 6. A multiplicity of cross beams 4 arranged next to one another in the longitudinal direction of the aircraft forms a supporting structure for an aircraft floor. A seating rail 10 for passenger seats is represented in an exemplary manner.

The cross beam 4 has an I-shaped profile with a top flange 12, a bottom flange 14, and a web 16. The web 16 extends between the flanges 12, 14 and in the conjoining region of the cross beam 4 is located in surface contact with the structure part 6. To conjoin the cross beam 4 to the structure part 6 the cross beam 4 is designed at its end sections with flanges 12, 14 that are stepped back on one side, so that in these regions the cross beam 4 has a C-shaped profile in each case.

A simulated load of the cross beam 4, by passengers, for example, is indicated by the arrow 18. The load 18 is introduced vertically into the top flange 12.

The structure part 6 is a rib, which runs in the circumferential direction of the aircraft fuselage and on the inner side of the fuselage it is riveted to an aircraft skin 20.

The conjoining 2 of the cross beam 4 with the rib 6 takes place via a multiplicity of rivets 22, 24, which are represented here as crosses. The rivets 22, 24 form two concentric circular paths 26, 28, which in the figure are indicated as dashed lines. In this manner a rivet pattern with two circular rows of rivets is formed. The rivets 22, 24 are evenly separated from one another on their respective circular paths 26, 28, and have a uniform outer diameter. Correspondingly rivet holes, not shown, in the cross beam 4 and in the rib 6 have a uniform inner diameter.

The circular paths 26, 28 are concentrically positioned about a locating bore 30. The locating bore 30 extends through the cross beam 4 and the rib 6 and provides accommodation for a locating pin during the installation of the cross beam 4.

The load 18 leads to a bending of the cross beam 4 and the rivets 22, 24 are subjected to shear loads. At the same time the cross beam 4 and the rib 6 in the conjoining region are subjected in particular to bearing stresses in the holes and shear stresses. By virtue of the ring-type arrangement of the rivets 22, 24 the load is distributed at least onto all rivets 22, 24 of the outer circular path 26, or row of rivets, as a result of which the load on each individual rivet 22, 24 is reduced, as are the stresses in the cross beam 4 and the rib 6 in the conjoining region. The ring-type introduction, i.e. distribution, of the load 18 onto the rivets 22, 24 on their respective circular path 26, 28 is indicated by the arrows 32 orientated along the circular path 26.

FIG. 2 shows a second example of embodiment of a conjunction 2 according to the invention between a cross beam 4 and a rib 6 of an aircraft fuselage. The single difference from the example of embodiment according to FIG. 1 consists in the fact that in place of a multiplicity of conjunction devices 22, 24 for mounting the cross beam 4 to the rib 6 only one bolt 34 is provided. Accordingly this conjunction can easily be separated and remanufactured, so that a cross beam 4 can be quickly replaced.

The bolt 34 has a cross-sectional area that corresponds to the sum of the individual cross-sectional areas of the conjunction devices 22, 24 required for this purpose in accordance with the first example of embodiment according to FIG. 1. It is designed as a cylindrical fitted bolt, and is supported in each case by one bush positioned in the cross beam 4 and one bush positioned in the rib 6, and is appropriately secured such that it cannot slide out of the bushes axially.

The bushes are not represented in the figure and are inserted in corresponding bores of the cross beam and the rib. The rib-side bush has a cylindrical inner wall, not visible in the figure, and the cross beam-side bush has a conical inner wall 36. The conical inner wall 36 tapers in a direction away from the rib 6. This has a self-centering effect during installation of the cross beam 4, so that during replacement of a cross beam, for example, compensation can be effected for any distortion of the rib 6 or any movement out of position of the rib-side bush.

The inner wall 36 of the bore in the cross beam 4 forms a circular path 26 in accordance with the invention, via which the loads 18 acting on the cross beam 4 are applied in the bolt 34 and from there into the rib 6. By virtue of the circular introduction of force the shear loads in the bolt 34, the bearing stresses in the holes, and the shear stresses in the cross beam 4 and the rib 6, are also reduced in this example of embodiment.

Disclosed is a conjunction 2 for mounting a cross beam 4 to a structure part 6 of an aircraft fuselage by means of at least one conjunction device 22, 24, 34, whereby the conjunction device 22, 24, 34, defines a circular path 26, 28, on which loads 18 acting on the cross beam 4 are applied in the structure element 6.

### REFERENCE SYMBOL LIST

2 Conjunction
4 Cross beam
6 Structure part
8 End section
10 Seating rail
12 Top flange
14 Bottom flange
16 Web
18 Load
20 Aircraft skin
22 Rivet
24 Rivet
26 Circular path
28 Circular path
30 Locating bore
32 Ring-type introduction
34 Bolt
36 Conical inner wall

What is claimed is:

1. An apparatus comprising:
a cross beam;
a structure part of an aircraft fuselage;
at least one conjunction device attaching the cross beam to the structure part, wherein the at least one conjunction device defines a circular path for the introduction of loads from the cross beam into the structural part.

2. The apparatus as recited in claim 1, wherein the at least one conjunction device includes a multiplicity of conjunction devices disposed in a ring-type arrangement so as to define the circular path.

3. The apparatus as recited in claim 2, wherein the conjunction devices further define a further circular path arranged concentrically with the circular path.

4. The apparatus as recited in claim 3, wherein the cross beam includes a loading bore, and wherein the circular path and the further circular path are disposed concentrically relative to the locating bore.

5. The apparatus as recited in claim 2, wherein multiplicity of conjunction devices includes a multiplicity of rivets.

6. The apparatus as recited in claim 1, wherein the at least one conjunction device is a bolt.

7. The apparatus as recited in claim 6, wherein the bolt has a cross-sectional area including a multiplicity of rivets.

8. The apparatus as recited in claim 6, wherein the bolt is guided in a bush.

9. The apparatus as recited in claim 8, wherein the bush is disposed inserted in the structure part and has a cylindrical inner wall.

10. The apparatus as recited in claim 8, wherein the bush is disposed in the cross beam and has a conical inner wall.
